(19) United States
(12) Patent Application Publication
(10) Pub. No.: US 2023/0162039 A1
(43) Pub. Date: May 25, 2023

(54) SELECTIVE DROPOUT OF FEATURES FOR ADVERSARIAL ROBUSTNESS OF NEURAL NETWORK

(71) Applicant: GM Global Technology Operations LLC, Detroit, MI (US)

(72) Inventors: Siddhartha Gupta, Rochester Hills, MI (US); Jacob Alan Bond, Rochester Hills, MI (US); Wei Tong, Troy, MI (US); Upali P. Mudalige, Oakland Township, MI (US)

(21) Appl. No.: 17/535,129

(22) Filed: Nov. 24, 2021

(51) Int. Cl. G06N 3/08; G06V 10/75; G06V 10/82

(52) U.S. Cl. CPC G06N 3/084; G06V 10/751; G06V 10/82

(57) ABSTRACT

A system comprises a computer including a processor and a memory. The memory includes instructions such that the processor is programmed to: receive, at a selective dropout layer of a neural network, a plurality of adversarial image features and a plurality of natural image features, select one or more nodes within the selective dropout layer to deactivate based on a comparison of the plurality of adversarial image features with the plurality of natural image features, and deactivate the selected one or more nodes.

### INTRODUCTION

The present disclosure relates to selectively dropping one or more neurons within a neural network to increase robustness against adversarial attacks.

Deep neural networks (DNNs) can be used to perform many image understanding tasks, including classification, segmentation, and captioning. Typically, DNNs require large amounts of training images (tens of thousands to millions). Additionally, these training images typically need to be annotated, e.g., labeled, for the purposes of training and prediction.

Additionally, conventional DNNs can be susceptible to adversarial attacks. For example, conventional DNNs may be vulnerable to adversarial attacks in which noisy input causes the DNNs to behave abnormally, such as generating inaccurate predictions and/or classifications.

### SUMMARY

A system comprises a computer including a processor and a memory. The memory includes instructions such that the processor is programmed to: receive, at a selective dropout layer of a neural network, a plurality of adversarial image features and a plurality of natural image features, select one or more nodes within the selective dropout layer to deactivate based on a comparison of the plurality of adversarial image features with the plurality of natural image features, and deactivate the selected one or more nodes.

In other features, the processor is further programmed to receive a sensitivity threshold.

In other features, the processor is further programmed to select the one or more nodes within the selective dropout layer to deactivate based on the comparison and the sensitivity threshold.

In other features, the processor is further programmed to calculate a loss function after the selected one or more nodes are deactivated.

In other features, the processor is further programmed to update one or more weights within the neural network based on the loss function.

In other features, the processor is further programmed to update the one or more weights within the neural network based on the loss function via backpropagation.

In other features, the processor is further programmed to generate the plurality of adversarial image features via a pretrained neural network based on a plurality of adversarial images provided to the pretrained neural network.

In other features, the pretrained neural network comprises a pretrained convolutional neural network.

In other features, the pretrained convolutional neural network comprises a Visual Geometry Group (VGG) 19 neural network.

In other features, the neural network generates the plurality of natural features based a plurality of natural images.

A method includes receiving, at a selective dropout layer of a neural network, a plurality of adversarial image features and a plurality of natural image features, selecting one or more nodes within the selective dropout layer to deactivate based on a comparison of the plurality of adversarial image features with the plurality of natural image features, and deactivating the selected one or more nodes.

In other features, the method includes receiving a sensitivity threshold.

In other features, the method includes selecting the one or more nodes within the selective dropout layer to deactivate based on the comparison and the sensitivity threshold.

In other features, the method includes calculating a loss function after the selected one or more nodes are deactivated.

In other features, the method includes updating one or more weights within the neural network based on the loss function.

In other features, the method includes updating the one or more weights within the neural network based on the loss function via backpropagation.

In other features, the method includes generating the plurality of adversarial image features via a pretrained neural network based on a plurality of adversarial images provided to the pretrained neural network.

In other features, the pretrained neural network comprises a pretrained convolutional neural network.

In other features, the pretrained convolutional neural network comprises a Visual Geometry Group (VGG) 19 neural network.

In other features, the neural network generates the plurality of natural features based a plurality of natural images.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a block diagram of an example system including a vehicle;

FIG. 2 is a block diagram of an example server within the system;

FIG. 3 is a block diagram of an example computing device;

FIG. 4 is a diagram of an example neural network;

FIG. 5 is a diagram of an example neural network in which multiple nodes have been deactivated within a selective dropout layer;

FIGS. 6A through 6C are block diagrams illustrating an example process for training one or more neural networks; and

FIG. 7 is a flow diagram illustrating an example process for training a neural network to selective dropout one or more nodes within a selective dropout layer.

### DETAILED DESCRIPTION

The following description is merely exemplary in nature and is not intended to limit the present disclosure, application, or uses.

The present disclosure discloses one or more implementations that generates a neural network with improved robustness against adversarial attacks through selective dropout of one or more nodes within a selective dropout layer. The selective dropout layer may comprise one or more hidden layers within the neural network. The selective dropout layer may be selected based on empirical analysis based on the desired usage of the neural network, e.g., object classification, object identification, etc.

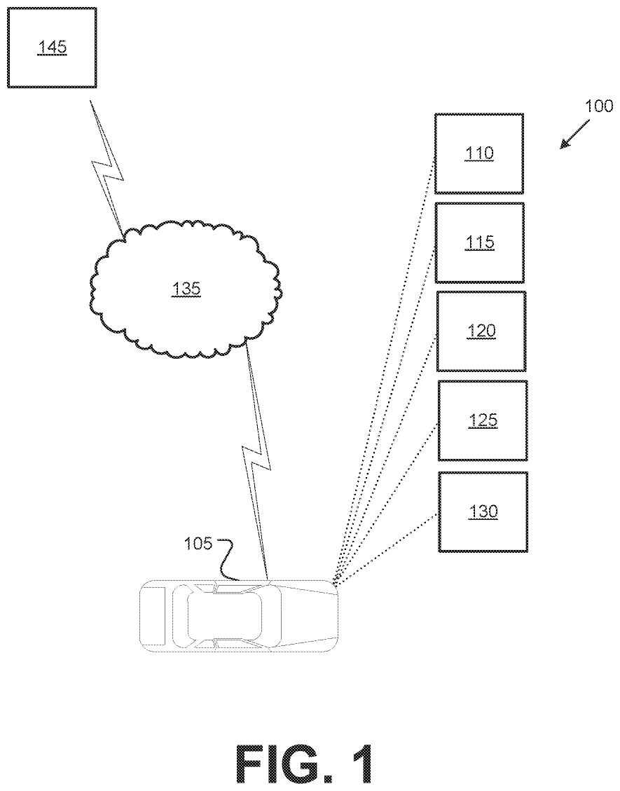

FIG. 1 is a block diagram of an example vehicle system 100. The system 100 includes a vehicle 105, which is a land vehicle such as a car, truck, etc. The vehicle 105 includes a computer 110, vehicle sensors 115, actuators 120 to actuate various vehicle components 125, and a vehicle communications module 130. Via a network 135, the communications module 130 allows the computer 110 to communicate with a server 145.

The computer 110 may operate a vehicle 105 in an autonomous, a semi-autonomous mode, or a non-autonomous (manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via the vehicle 105 communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the computer 110 may communicate, via the vehicle 105 communications module 130, with a navigation system that uses the Global Position System (GPS). As an example, the computer 110 may request and receive location data of the vehicle 105. The location data may be in a known form, e.g., geo-coordinates (latitudinal and longitudinal coordinates).

The computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

Via the vehicle 105 communications network, the computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the computer 110 actually comprises a plurality of devices, the vehicle 105 communications network may be used for communications between devices represented as the computer 110 in this disclosure. Further, as mentioned below, various controllers and/or vehicle sensors 115 may provide data to the computer 110. The vehicle 105 communications network can include one or more gateway modules that provide interoperability between various networks and devices within the vehicle 105, such as protocol translators, impedance matchers, rate converters, and the like.

Vehicle sensors 115 may include a variety of devices such as are known to provide data to the computer 110. For example, the vehicle sensors 115 may include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects (possibly including second vehicles 106), etc., relative to the location of the vehicle 105. The vehicle sensors 115 may further include camera sensor(s) 115, e.g., front view, side view, rear view, etc., providing images from a field of view inside and/or outside the vehicle 105.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the computer 110 may be configured for communicating via a vehicle-to-vehicle communication module or interface 130 with devices outside of the vehicle 105, e.g., through a vehicle to vehicle (V2V) or vehicle-to-infrastructure (V2X) wireless communications to another vehicle, to (typically via the network 135) a remote server 145. The module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short-range communications (DSRC), and/or wide area networks (WAN), including the Internet, providing data communication services.

The network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

A computer 110 can receive and analyze data from sensors 115 substantially continuously, periodically, and/or when instructed by a server 145, etc. Further, object classification or identification techniques can be used, e.g., in a computer 110 based on lidar sensor 115, camera sensor 115, etc., data, to identify a type of object, e.g., vehicle, person, rock, pothole, bicycle, motorcycle, etc., as well as physical features of objects.

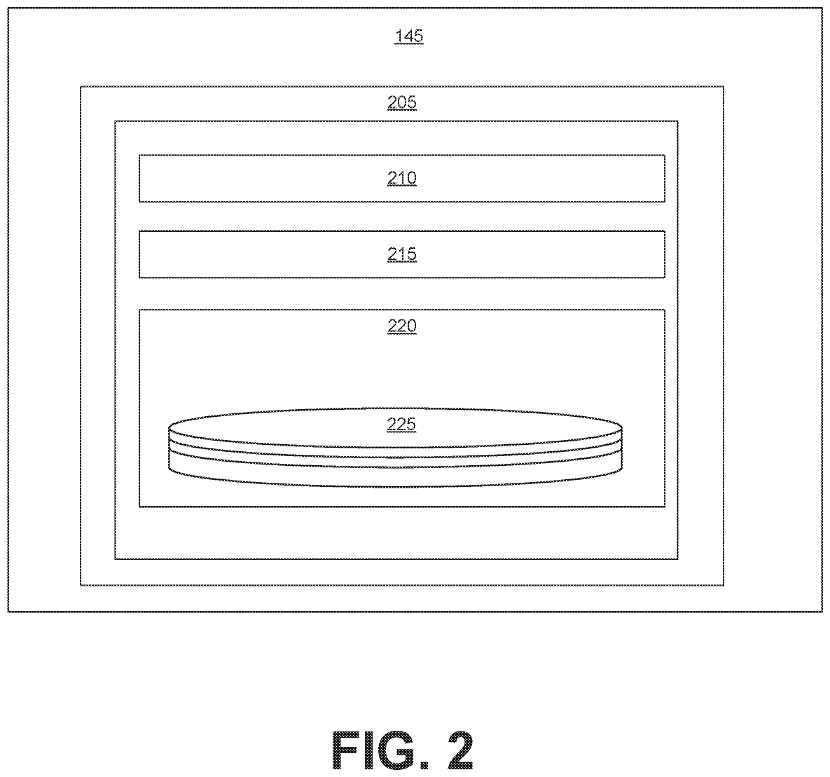

FIG. 2 illustrates an example server 145 that includes a selective dropout neural-network training system 205. As shown, the selective dropout neural-network training system 205 may include a neural network module 210, a selective dropout module 215, and a storage module 220.

As just mentioned, the selective dropout neural-network training system 205 can include a neural network module 210. In particular, the neural network module 210 can manage, maintain, train, implement, utilize, or communicate with one or more neural networks. For example, the neural network module 210 can communicate with the storage module 220 to access a neural network, e.g., neural network 400, stored within the database 225. In addition, the selective dropout neural-network training system 205 can communicate with the selective dropout module 215 to train and implement a neural network to classify digital images or generate predictions for other possible domains.

The selective dropout module 215 can train and implement a neural network based on a selective dropout routine, as described herein. For example, the selective dropout module 215 can communicate with the neural network module 210 and the storage module 220 to access a neural network stored within the database 225. In addition, the selective dropout module 215 can determine gradient losses associated with classification labels for a number of neurons within the neural network.

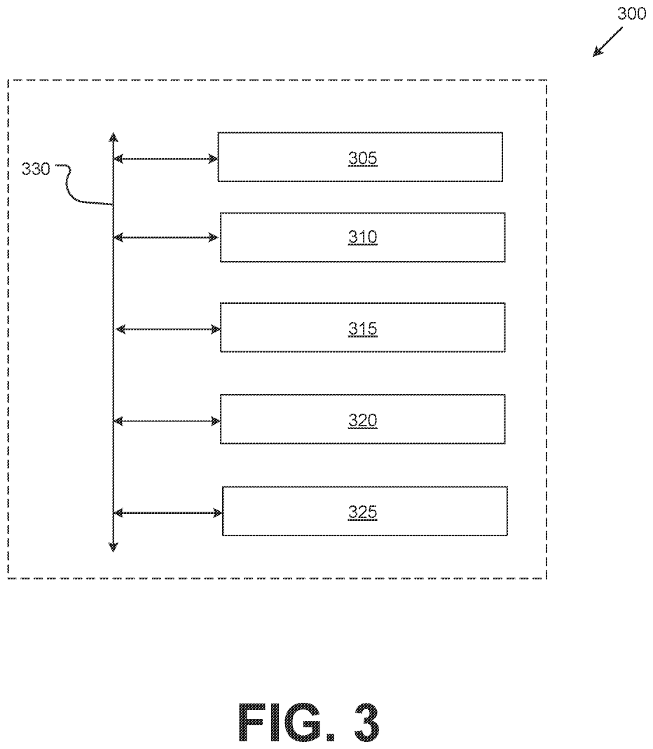

FIG. 3 illustrates an example computing device 300 i.e., computer 110 and/or server(s)145 that may be configured to perform one or more of the processes described herein. As shown, the computing device can comprise a processor 305, memory 310, a storage device 315, an I/O interface 320, and a communication interface 325. Furthermore, the computing device 300 can include an input device such as a touchscreen, mouse, keyboard, etc. In certain implementations, the computing device 300 can include fewer or more components than those shown in FIG. 3.

In particular implementations, processor(s) 305 includes hardware for executing instructions, such as those making up a computer program. As an example, and not by way of limitation, to execute instructions, processor(s) 305 may retrieve (or fetch) the instructions from an internal register, an internal cache, memory 310, or a storage device 315 and decode and execute them.

The computing device 300 includes memory 310, which is coupled to the processor(s) 305. The memory 310 may be used for storing data, metadata, and programs for execution by the processor(s). The memory 310 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 310 may be internal or distributed memory.

The computing device 300 includes a storage device 315 includes storage for storing data or instructions. As an example, and not by way of limitation, storage device 315 can comprise a non-transitory storage medium described above. The storage device 315 may include a hard disk drive (HDD), flash memory, a Universal Serial Bus (USB) drive or a combination of these or other storage devices.

The computing device 300 also includes one or more input or output (“I/O”) devices/interfaces 320, which are provided to allow a user to provide input to (such as user strokes), receive output from, and otherwise transfer data to and from the computing device 300. These I/O devices/interfaces 320 may include a mouse, keypad or a keyboard, a touch screen, camera, optical scanner, network interface, modem, other known I/O devices or a combination of such I/O devices/interfaces 320. The touch screen may be activated with a writing device or a finger.

The I/O devices/interfaces 320 may include one or more devices for presenting output to a user, including, but not limited to, a graphics engine, a display (e.g., a display screen), one or more output drivers (e.g., display drivers), one or more audio speakers, and one or more audio drivers. In certain implementations, devices/interfaces 320 is configured to provide graphical data to a display for presentation to a user. The graphical data may be representative of one or more graphical user interfaces and/or any other graphical content as may serve a particular implementation.

The computing device 300 can further include a communication interface 325. The communication interface 325 can include hardware, software, or both. The communication interface 325 can provide one or more interfaces for communication (such as, for example, packet-based communication) between the computing device and one or more other computing devices 300 or one or more networks. As an example, and not by way of limitation, communication interface 325 may include a network interface controller (NIC) or network adapter for communicating with an Ethernet or other wire-based network or a wireless NIC (WNIC) or wireless adapter for communicating with a wireless network, such as a WI-FI. The computing device 300 can further include a bus 330. The bus 330 can comprise hardware, software, or both that couples components of computing device 300 to each other.

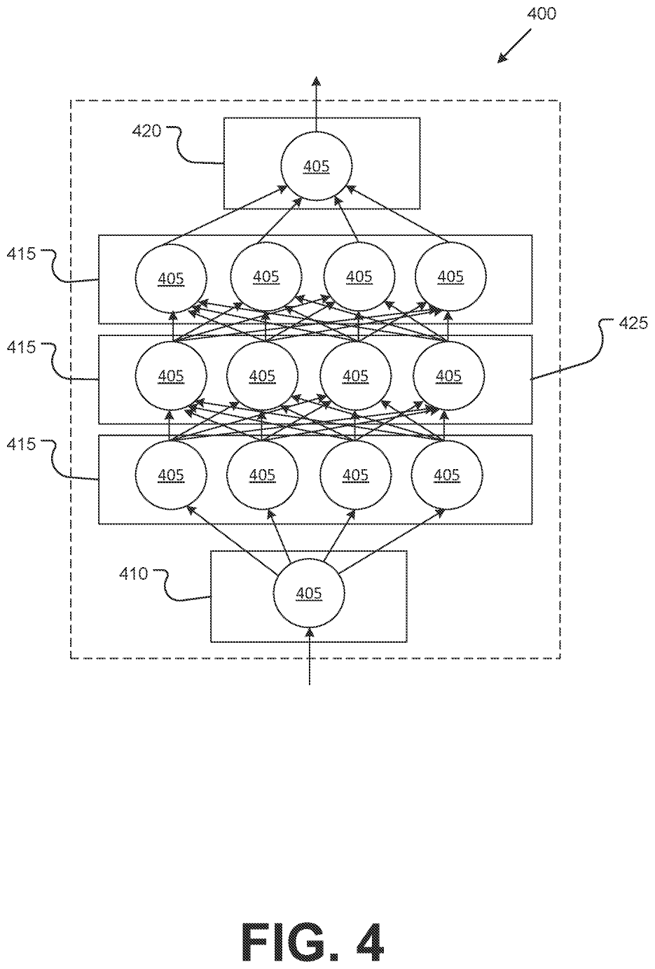

FIG. 4 is a diagram of an example deep neural network (DNN) 400 that may be used herein. The DNN 400 includes multiple nodes 405, and the nodes 405 are arranged so that the DNN 400 includes an input layer 410, one or more hidden layers 415, and an output layer 420. Each layer of the DNN 400 can include a plurality of nodes 405. While FIG. 4 illustrates three (3) hidden layers 415, it is understood that the DNN 400 can include additional or fewer hidden layers. The input and output layers 410, 420 may also include more than one (1) node 405. As shown, one of the hidden layers 415 comprises a selective dropout layer 425. The selective dropout layer 425 comprises a hidden layer in which one or more nodes 405 are deactivated. As described in greater detail below, the one or more nodes 405 are deactivated based on adversarial image features that perturb the one or more nodes 405 more than a predefined perturbation threshold. The predefined perturbation threshold can be determined through empirical analysis according to the usage of the DNN 400, i.e., object classification, object identification, etc.

The nodes 405 are sometimes referred to as artificial neurons, because they are designed to emulate biological, e.g., human, neurons. A set of inputs (represented by the arrows) to each node 405 are each multiplied by respective weights. The weighted inputs can then be summed in an input function to provide, possibly adjusted by a bias, a net input. The net input can then be provided to activation function, which in turn provides a connected node 405 an output. The activation function can be a variety of suitable functions, typically selected based on empirical analysis. As illustrated by the arrows in FIG. 4, node 405 outputs can then be provided for inclusion in a set of inputs to one or more neurons 305 in a next layer.

The DNN 400 can be trained to accept data as input and generate an output based on the input. In one example, the DNN 400 can be trained with ground truth data, i.e., data about a real-world condition or state. For instance, the DNN 400 can be trained with ground truth data or updated with additional data by a processor. Weights can be initialized by using a Gaussian distribution, for example, and a bias for each node 405 can be set to zero. Training the DNN 400 can including updating weights and biases via suitable techniques such as backpropagation with optimizations. Ground truth data can include, but is not limited to, data specifying objects within an image or data specifying a physical parameter, e.g., angle, speed, distance, color, hue, or angle of object relative to another object. For example, the ground truth data may be data representing objects and object labels.

Machine learning services, such as those based on Recurrent Neural Networks (RNNs), Convolutional Neural Networks (CNNs), Long Short-Term Memory (LSTM) neural networks, or Gated Recurrent Unit (GRUs) may be implemented using the DNNs 400 described in this disclosure. In one example, the service-related content or other information, such as words, sentences, images, videos, or other such content/information may be translated into a vector representation.

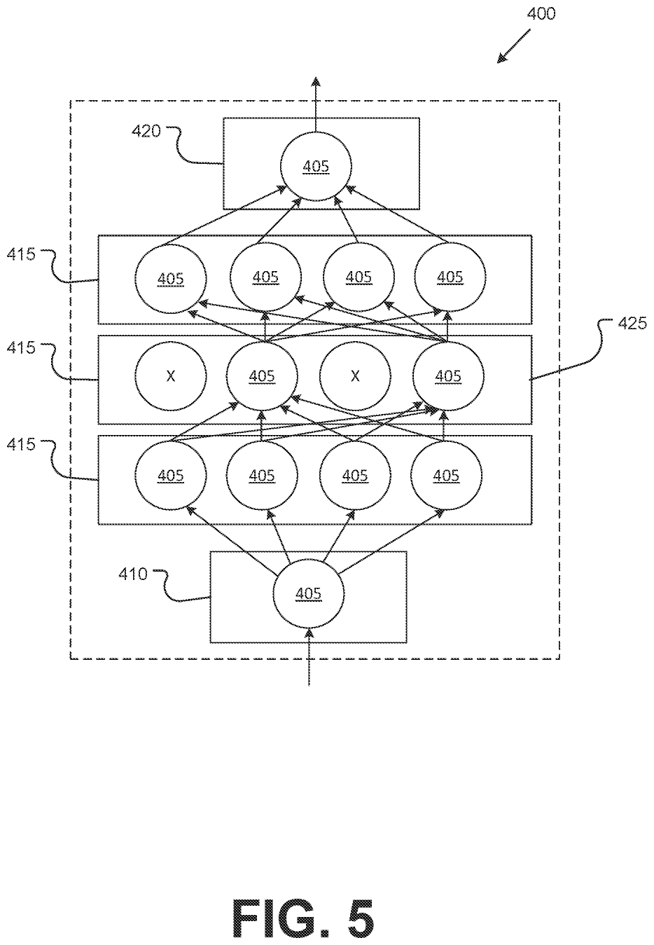

FIG. 5 illustrates an example DNN 400 in which multiple nodes 405 have been selectively deactivated, or dropped out, due to adversarial image features perturbing the nodes 405 more than a predefined perturbation threshold.

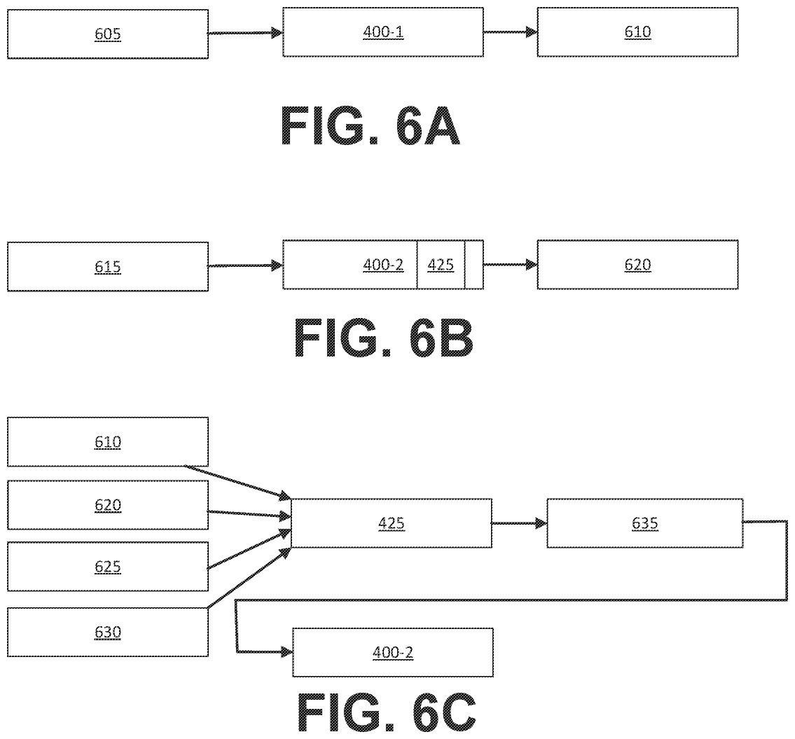

FIGS. 6A through 6C illustrate an example process for selectively dropping out one or more nodes 405 within the DNN 400 in accordance with one or more implementations of the present disclosure. As shown in FIG. 6A, a pre-trained DNN 400-1 receives a set of adversarial images 605 and generates adversarial image features 610. For example, the adversarial images 605 may comprise a digital image of a traffic sign and noise input, i.e., perturbation, that causes typical neural networks to misclassify the object depicted within the image. The pre-trained DNN 400-1 is trained to generate the adversarial image features 610, which comprise latent or hidden features used by a neural network to generate a prediction. The pre-trained DNN 400-1 can generate the adversarial image features 610 via forward propagation. In various implementations, the pre-trained DNN 400-1 may comprise a pretrained convolutional neural network, such as a Visual Geometry Group (VGG) 19 neural network, or the like.

Referring to FIG. 6B, during a training phase of a DNN 400-2, the DNN 400-2 receives a set of natural images 615 and generates natural image features 620. As shown, the DNN 400-2 includes the selective dropout layer 425. The natural images 615 can comprise digital images of objects that are not perturbed. In other words, the natural images comprise images sourced from a real-world distribution. The natural image features 620 can comprise latent or hidden features used by a neural network to generate a prediction.

Referring to FIG. 6C, the adversarial image features 610, the natural image features 620, a sensitivity threshold 625, and a dropout probability 630 are provided to the selective dropout layer 425. The sensitivity threshold 625 and the dropout probability 630 can comprise positive real numbers less than one (1). The sensitivity threshold 625 and the dropout probability 630 can be determined through empirical analysis according to the desired usage of the DNN 400-2.

It is understood that the resultant features 610, 620 comprise d-dimensional vectors, where d is a real number greater than one (1). In various implementations, the selective dropout module 215 can pointwise compare the adversarial image features 610 and the natural image features 620 to obtain a comparison d-dimensional vector, where d is a real number greater than one (1). Each element of the d-dimensional vector comprises a real number between zero (0) and one (1).

The selective dropout module 215 can compare an output from the selective dropout layer 425 based on the features 610, 620. For example, the selective dropout module 215 determine a loss based on a predicted output generated by the selective dropout layer 425 with the ground truth.

The selective dropout module 215 can also compare the features 610, 620 through an absolute difference, an outer product, normalized correlation, or the like. The selective dropout module 215 then determines one or more nodes 405 to selectively dropout, e.g., deactivate, by comparing the resulting value of each element of the d-dimensional vector to the sensitivity threshold 625. For example, the node 405 corresponding to an element selected for dropout is set to zero (0). The selective dropout module 215 can selectively dropout nodes 405 according to the dropout probability. The resulting vector, i.e., vector after the elements have been set to zero (0), can be re-scaled to adjust the expected value of the vector. The selective dropout module 215 then returns the adjusted feature vector. The adjusted feature vector is then forward propagated through subsequent layers, i.e., layers after the selective dropout layer 425, of the DNN 400-2. The selective dropout module 215 can then calculate a loss function. One or more weights of the DNN 400-2 can then be updated through techniques such as backpropagation with optimizations based on the calculated loss function.

The process described can occur multiple times. For example, the process can continue until a desired accuracy is achieved or a desired loss convergence is achieved. The resulting trained DNN 400-2 can result in a neural network that is more robust against adversarial attacks by deactivating nodes 405 that may be more susceptible to adversarial features.

Once trained, the DNN 400-2 can be provided to the vehicle 105. The computer 110 can employ the DNN 400-2 to perform object classification and/or object identification using images captured by the sensors 115. Based on the object classification and/or object identification, the computer 110 may operate the vehicle based on one or more vehicle operation protocols, i.e., transitioning from an autonomous mode of operation to a semi-autonomous mode of operation, modifying a vehicle speed and/or vehicle direction, etc.

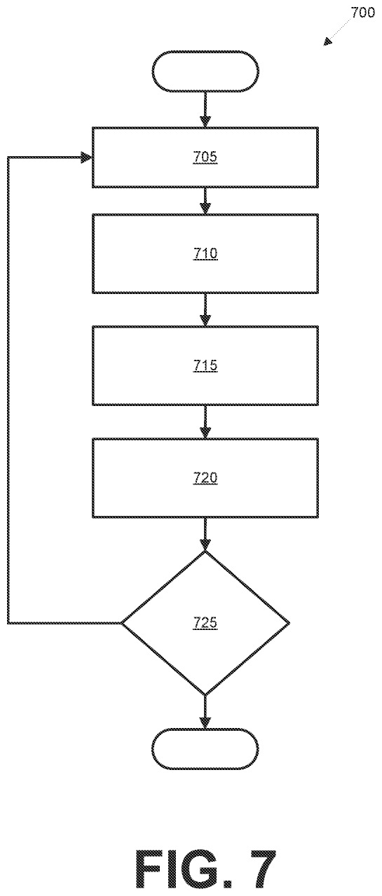

FIG. 7 is a flowchart of an example process 700 for training a DNN 400, such as the DNN 400-2, according to the techniques described herein. Blocks of the process 700 can be executed by the server 145. The process 700 begins at block 705 in which adversarial image features 610 are generated. As discussed above, the pre-trained DNN 400-1 generates one or more adversarial image features 610 based on one or more adversarial images 605, such as a batch of adversarial images, provided to the DNN 400-1.

At block 710, natural image features 620 are generated by the DNN 400-2. For example, the DNN 400-2 generates one or more natural image features 620 based on one or more natural images 615, such as a batch of natural images, provided to the DNN 400-2. At block 715, one or more nodes 405 of the DNN 400-2 are selectively deactivated based on a comparison of the adversarial image features 610 and the natural image features 620 as discussed above in reference to FIG. 6C. At block 720, one or more weights of the DNN 400-2 are updated after the nodes 405 are deactivated. For example, the one or more weights of the DNN 400-2 can be determined based on a calculated loss function that considers a plurality of classification labels as compared to ground truth.

At block 725, a determination is made whether an accuracy threshold or a loss convergence has been attained. If neither the accuracy threshold nor the loss convergence has been attained, the process 700 returns to block 705. Otherwise, the process 700 ends.

The description of the present disclosure is merely exemplary in nature and variations that do not depart from the gist of the present disclosure are intended to be within the scope of the present disclosure. Such variations are not to be regarded as a departure from the spirit and scope of the present disclosure.

In general, the computing systems and/or devices described may employ any of a number of computer operating systems, including, but by no means limited to, versions and/or varieties of the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer readable medium (also referred to as a processor readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain implementations, and should in no way be construed so as to limit the claims.

Accordingly, it is to be understood that the above description is intended to be illustrative and not restrictive. Many implementations and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future implementations. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising a computer including a processor and a memory, the memory including instructions such that the processor is programmed to:
receive, at a selective dropout layer of a neural network, a plurality of adversarial image features and a plurality of natural image features;
select one or more nodes within the selective dropout layer to deactivate based on a comparison of the plurality of adversarial image features with the plurality of natural image features; and
deactivate the selected one or more nodes.

2. The system of claim 1, wherein the processor is further programmed to receive a sensitivity threshold.

3. The system of claim 2, wherein the processor is further programmed to select the one or more nodes within the selective dropout layer to deactivate based on the comparison and the sensitivity threshold.

4. The system of claim 1, wherein the processor is further programmed to calculate a loss function after the selected one or more nodes are deactivated.

5. The system of claim 4, wherein the processor is further programmed to update one or more weights within the neural network based on the loss function.

6. The system of claim 5, wherein the processor is further programmed to update the one or more weights within the neural network based on the loss function via backpropagation.

7. The system of claim 1, wherein the processor is further programmed to generate the plurality of adversarial image features via a pretrained neural network based on a plurality of adversarial images provided to the pretrained neural network.

8. The system of claim 7, wherein the pretrained neural network comprises a pretrained convolutional neural network.

9. The system of claim 8, wherein the pretrained convolutional neural network comprises a Visual Geometry Group (VGG) 19 neural network.

10. The system of claim 1, wherein the neural network generates the plurality of natural features based a plurality of natural images.

11. A method comprising:
receiving, at a selective dropout layer of a neural network, a plurality of adversarial image features and a plurality of natural image features;
selecting one or more nodes within the selective dropout layer to deactivate based on a comparison of the plurality of adversarial image features with the plurality of natural image features; and
deactivating the selected one or more nodes.

12. The method of claim 11, the method further comprising receiving a sensitivity threshold.

13. The method of claim 12, the method further comprising selecting the one or more nodes within the selective dropout layer to deactivate based on the comparison and the sensitivity threshold.

14. The method of claim 11, the method further comprising calculating a loss function after the selected one or more nodes are deactivated.

15. The method of claim 14, the method further comprising updating one or more weights within the neural network based on the loss function.

16. The method of claim 11, the method further comprising updating the one or more weights within the neural network based on the loss function via backpropagation.

17. The method of claim 11, the method further comprising generating the plurality of adversarial image features via a pretrained neural network based on a plurality of adversarial images provided to the pretrained neural network.

18. The method of claim 17, wherein the pretrained neural network comprises a pretrained convolutional neural network.

19. The method of claim 18, wherein the pretrained convolutional neural network comprises a Visual Geometry Group (VGG) 19 neural network.

20. The method of claim 11, wherein the neural network generates the plurality of natural features based a plurality of natural images.
